(19) United States
(12) Patent Application Publication
(10) Pub. No.: US 2013/0092851 A1
(43) Pub. Date: Apr. 18, 2013

(54) LIQUID LEVEL INDICATION DEVICE

(71) Applicant: Disco Corporation, Tokyo (JP)

(72) Inventor: Kazuma SAKIYA, Tokyo (JP)

(73) Assignee: DISCO CORPORATION, Tokyo (JP)

(21) Appl. No.: 13/644,060

(22) Filed: Oct. 3, 2012

(30) Foreign Application Priority Data
Oct. 14, 2011 (JP) 2011-226585

(51) Int. Cl. G01F 23/292

(52) U.S. Cl. 250/577

(57) ABSTRACT

A device for indicating the level of a liquid contained in a tank. The liquid level indication device includes: a liquid level measuring unit for measuring the level of the liquid contained in the tank; an indicating unit disposed outside of the tank to indicate the level of the liquid measured by the liquid level measuring unit; and a controller for outputting to the indicating unit a control signal based on a measurement signal obtained on measurement by the liquid level measuring unit. The indicating unit is provided with a plurality of light-emitting elements which are located respectively at positions corresponding to a plurality of positions ranging from an uppermost position to a lowermost position of the level of the liquid contained in the tank. The controller causes the light-emitting elements corresponding to the liquid level measured by the liquid level measuring unit to emit light.

### BACKGROUND OF THE INVENTION

1. Field of the Invention

The present invention relates to a device for indicating the level of a liquid contained in a tank.

2. Description of the Related Art

A liquid such as kerosene, water, milk and liquors is contained in a tank formed of stainless steel or the like, and is delivered to consumers in the state of being portioned into PET bottles, glass bottles, cans or the like. In the case where such a tank for containing a liquid is formed of a transparent or translucent material, the level of the liquid contained in the tank can be externally checked, and the residual amount of the liquid can be grasped by the naked eye. Where the liquid-containing tank is formed of an opaque material such as stainless steel, however, the level of the liquid, or the residual amount of the liquid, cannot be checked by the naked eye.

As a method for checking the level of a liquid contained in a tank formed of an opaque material, there has been commonly used a method wherein a liquid level monitoring tube formed of a transparent glass or the like and communicating with a bottom portion of the tank is disposed rising along a side surface of the tank, and the level of the liquid contained in the tank is grasped by checking the liquid level inside the liquid level monitoring tube (refer to, for example, Japanese Patent Laid-open No. Hei 4-42022).

### SUMMARY OF THE INVENTION

According to the method based on the use of the liquid level monitoring tube formed of a transparent glass or the like and communicating with a lower portion of a tank, the liquid contained in the tank is exposed to light. Therefore, this method is not preferable in the cases of liquids the quality of which is lowered by exposure to light, such as wines and other liquors.

Accordingly, it is an object of the present invention to provide a liquid level indication device by which the level of a liquid contained in a tank can be checked, without exposing the liquid to light, even where the tank is formed of an opaque material.

In accordance with an aspect of the present invention, there is provided a device for indicating the level of a liquid contained in a tank, including: means for measuring the level of the liquid contained in the tank; means for indicating the level of the liquid measured by the liquid level measuring means, the indicating means disposed outside of the tank and provided with a plurality of light-emitting elements which are located respectively at positions corresponding to a plurality of positions ranging from an uppermost position to a lower most position of the level of the liquid contained in the tank; and control means for outputting to the indicating means a control signal based on a measurement signal obtained on measurement by the liquid level measuring means, wherein the control means causes the light-emitting elements corresponding to the liquid level measured by the liquid level measuring means to emit light.

According to the present invention, the indicating means is provided with the plurality of light-emitting elements which are disposed respectively at positions corresponding to a plurality of positions ranging from the uppermost position to the lowermost position of the level of the liquid contained in the tank, and the control means causes the light-emitting elements corresponding to the liquid level measured by the liquid level measuring means to emit light. This ensures that the level of the liquid contained in the tank can be checked by the naked eye. In addition, since a liquid level monitoring tube formed of a transparent glass or the like for checking the level of the liquid contained in the tank is not used, it is possible, by forming the tank from an opaque material, to maintain the quality of the liquid contained in the tank even where the liquid is a liquor such as wine.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a tank equipped with a liquid level indication device configured according to the present invention;

FIG. 2 is a sectional view of the tank equipped with the liquid level indication device configured according to the present invention; and

FIG. 3 is an illustration of a control map stored in a memory of control means which constitutes the liquid level indication device configured according to the present invention.

### DETAILED DESCRIPTION OF THE PREFERRED EMBODIMENT

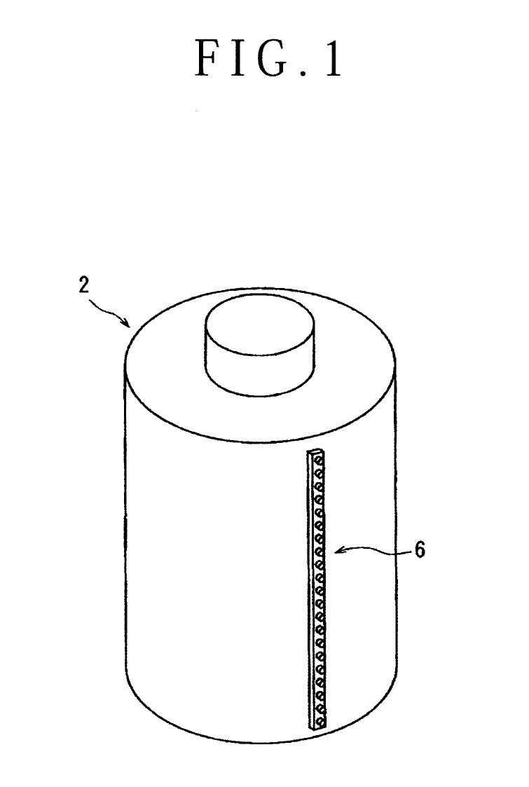

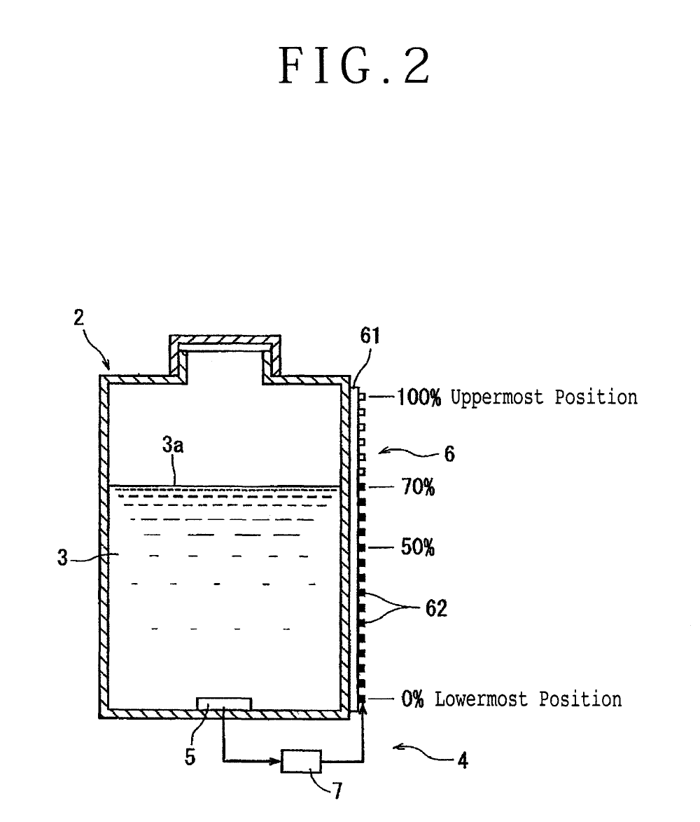

Now, a preferred embodiment of the liquid level indication device configured according to the present invention will be described in detail below, referring to the attached drawings. FIG. 1 shows a perspective view of a tank equipped with a liquid level indication device configured according to the present invention, and FIG. 2 shows a sectional view of the tank equipped with the liquid level indication device configured according to the present invention.

The tank 2 shown in FIGS. 1 and 2 is, in the embodiment shown, formed from an opaque material such as stainless steel. In the tank 2 is contained a liquid 3 which is a liquor such as wine, for example. In the embodiment shown in the figures, a liquid level indication device 4 is provided which indicates the level of the liquid 3 contained in the tank 2. The liquid level indication device 4 includes: a pressure sensor 5 as liquid level measuring means for measuring the level 3a of the liquid 3 contained in the tank 2; indicating means 6 disposed outside of the tank 2 to indicate the liquid level measured by the pressure sensor 5 serving as the liquid level measuring means; and control means 7 for outputting to the indicating means 6 a control signal based on a measurement signal obtained upon measurement by the pressure sensor 5 serving as the liquid level measuring means.

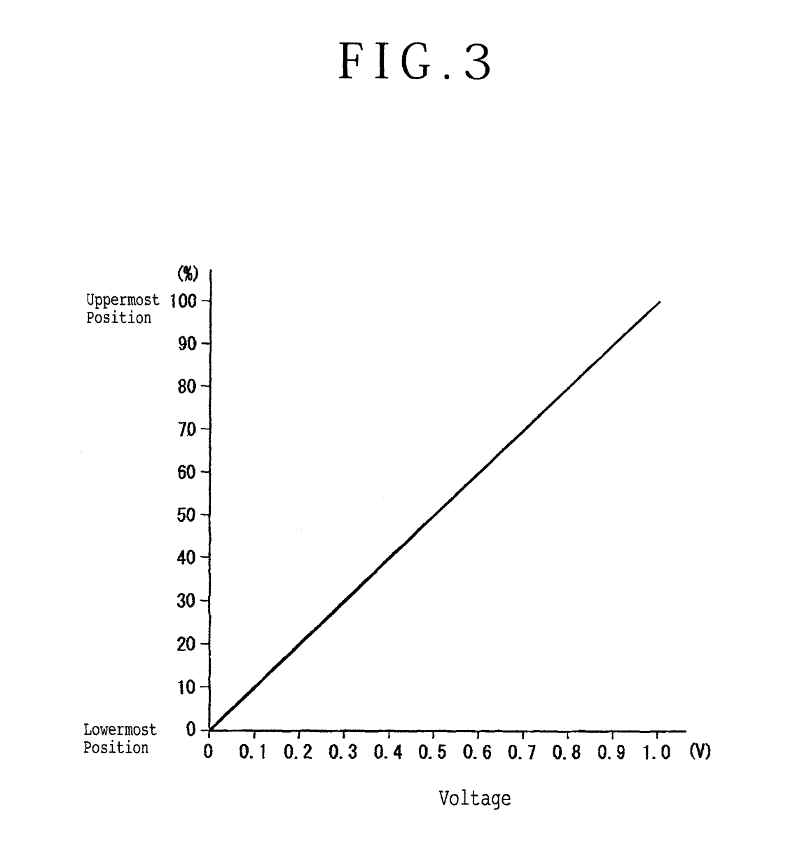

The pressure sensor 5 as the liquid level measuring means is disposed on a bottom surface of the tank 2, and outputs to the control means 7 a voltage signal corresponding to the pressure exerted thereon by the liquid 3 contained in the tank 2. When the level of the liquid 3 contained in the tank 2 is low, the pressure sensor 5 outputs a low voltage, since the pressure exerted thereon is low. When the level of the liquid contained in the tank 2 is high, the pressure sensor 5 outputs a high voltage, since the pressure exerted thereon is high. Now, the relationship between the voltage signal outputted from the pressure sensor 5 and the level of the liquid 3 contained in the tank 2 will be described, referring to a control map shown in FIG. 3. In FIG. 3, the axis of abscissas represents the voltage outputted from the pressure sensor 5, and the axis of ordinates represents, in %, the position of the level of the liquid 3 contained in the tank 2. Incidentally, the position of the liquid level taken on the axis of ordinates in FIG. 3 is so set that the uppermost position of the level of the liquid 3 contained in the tank 2 is 100%, whereas the lowermost position corresponding to the position of the surface of the pressure sensor 5 is 0%. In the control map shown in FIG. 3, a setting is made such that the pressure sensor 5 outputs a voltage signal of 1 V when the level of the liquid 3 contained in the tank 2 is 100% and that the pressure sensor 5 outputs a voltage signal of 0.5 V when the level of the liquid contained in the tank 2 is 50%. The control map shown in FIG. 3 which is set as just-mentioned is stored in a memory of the control means 7.

Now, the indicating means 6 will be described below. The indicating means 6 includes: a substrate 61 having a length ranging at least from the uppermost position (100%) to the lowermost position (0%) of the level of the liquid 3 contained in the tank 2; and a plurality of light-emitting elements 62 disposed on the substrate 61 respectively at positions corresponding to a plurality of positions ranging from the uppermost position (100%) to the lowermost position (0%). The indicating means 6 is mounted to an outside surface of the tank 2. Incidentally, light emitting diodes (LEDs) or a liquid crystal display can be used as the light-emitting elements 62. Of the indicating means 6 configured in this fashion, the plurality of light-emitting elements 62 are controlled by the control means 7.

When a voltage signal outputted from the pressure sensor 5 serving as the liquid level measuring means is inputted to the control means 7, the control means 7 determines the liquid level position (%) corresponding to the voltage by referring to the control map shown in FIG. 3, and outputs to the indicating means 6 a control signal corresponding to the liquid level position (%). For instance, when the voltage outputted from the pressure sensor 5 is 0.7 V, the control means 7 refers to the control map shown in FIG. 3, to find that the level of the liquid 3 contained in the tank 2 is 70%. Then, the control means 7 outputs to the indicating means 6 a control signal by which the light-emitting elements 62 corresponding to the liquid level of 70% are operated to emit light. Incidentally, in the embodiment shown in FIG. 2, there is shown a condition wherein the light-emitting elements 62 corresponding to the positions ranging from the lowermost position (0%) to the position of 70%, of the level of the liquid 3 contained in the tank 2, are emitting light. In other words, in the embodiment shown in FIG. 2, the light-emitting elements 62 at the positions corresponding to the residual amount of the liquid 3 contained in the tank 2 are operated to emit light.

In this manner, those light-emitting elements 62 of the indicating means 6 mounted to the outside surface of the tank 2 which correspond to the level of the liquid 3 contained in the tank 2 are caused to emit light. This ensures that the level of the liquid 3 contained in the tank 2 can be checked by the naked eye. In addition, in the liquid level indication device according to the embodiment shown in the figures, there is used no liquid level monitoring tube formed of a transparent glass or the like by which to check the level of a liquid contained in a tank. Therefore, by forming the tank from an opaque material it is possible to maintain the quality of the liquid contained in the tank, even where the liquid is a liquor such as wine.

While the present invention has been described above based on the embodiment shown in the drawings, the invention is not to be restricted to the embodiment, and various modifications are possible within the scope of the gist of the invention. For example, while the pressure sensor 5 as the liquid level measuring means is used in the above-described embodiment, a float sensor or an ultrasonic sensor or the like can also be used as the liquid level measuring means.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A device for indicating the level of a liquid contained in a tank, comprising:
means for measuring the level of the liquid contained in the tank;
means for indicating the level of the liquid measured by the liquid level measuring means, the indicating means disposed outside of the tank and provided with a plurality of light-emitting elements which are located respectively at positions corresponding to a plurality of positions ranging from an uppermost position to a lower most position of the level of the liquid contained in the tank; and
control means for outputting to the indicating means a control signal based on a measurement signal obtained on measurement by the liquid level measuring means,
wherein the control means causes the light-emitting elements corresponding to the liquid level measured by the liquid level measuring means to emit light.
